(19) United States
(12) Patent Application Publication
(10) Pub. No.: US 2006/0016738 A1
(43) Pub. Date: Jan. 26, 2006

(54) Addressing and printing apparatus and method

(76) Inventors: Michael O. Norris, Colleyville, TX (US); Dale E. Redford, Grand Prairie, TX (US)

Correspondence Address: Philip G. Meyers Law Office, Suite 300, 1009 Long Prairie Road, Flower Mound, TX, 75022, US

(21) Appl. No.: 11/182,514

(22) Filed: Jul. 15, 2005

Related U.S. Application Data
(60) Provisional application No. 60/588,531, filed on Jul. 16, 2004.

(51) Int. Cl. G06K 9/00; B07C 5/00

(52) U.S. Cl. 209/584

(57) ABSTRACT

A method of processing unsorted mail pieces for delivery includes the steps of sorting mail pieces destined for delivery to a single delivery point into a group, printing human readable destination information corresponding to the delivery point of the group on a section of wrapping material, and wrapping the group of mail pieces with the wrapping material bearing the human readable destination information in a complete or abbreviated form. A machine readable code, such as a bar code may also be printed on the wrapping material and subsequently scanned to insure proper sequencing of the bundles of wrapped mail pieces.

This application claims priority of U.S. Ser. No. 60/588,531, filed Jul. 16, 2004.

### TECHNICAL FIELD

The invention relates to mail processing for delivery, and in particular, to the use of prearranged or pre-ordered material used to package groups of letters, flats and small parcels to facilitate delivery of the mail.

### BACKGROUND OF THE INVENTION

Each day the United States Postal Service (USPS) receives, sorts and delivers millions of mail pieces to millions of postal patrons across the United States. In order to sort this huge volume of mail pieces faster and more efficiently, a number of different methods, machines and systems have been proposed. For example, U.S. Pat. No. 6,659,263, issued Dec. 9, 2003 to Hendrickson et al., proposes the use of staging towers disposed over a conveyor for collating flat mail pieces onto the conveyor. U.S. Pat. No. 6,555,776 issued Apr. 29, 2003 to Roth et al. discloses a system for sorting letters and flats in a single feed one pass mixed mail sequencer. Schererz et al., U.S. patent application Ser. No. 09/969,274, filed Oct. 2, 2001 (Publication No. U.S. 20020070149) is directed to a mixed mail sorting machine. Pippin et al., U.S. patent application Ser. No. 10/142,348, filed May 9, 2002 (Publication No. U.S. 200300386065) discloses an apparatus and method for mail sorting in which one or more delivery robots receive mail pieces and travel along a track to deliver the mail pieces to one of a plurality of destination slots.

Currently, mail carriers deliver mail pieces, including letters, flats and parcels, to postal patrons on a daily basis. At local postal offices, carriers receive mail for delivery from a number of sources, which may be unsorted or sorted to varying degrees. Letter mail typically arrives in several separate streams. First, manual letter mail origination from a processing facility arrives at the local postal office in the early morning hours. This mail may be pre-sorted by carrier route before delivery at the processing facility manual cases or through an automated sort. The mail carrier cases this mail to place it in delivery point order. Second, delivery sequenced letter mail arrives in trays that the carrier takes directly onto his or her route. Finally, the carrier receives non-automated enhanced carrier route letters that are prepared in delivery point sequence or line-of-travel order. The carrier may case this mail or take it directly onto his route.

In addition to letter mail, the carrier will receive tubs of carrier route flats from the processing facility which have been prepared by automated systems. The carrier will also receive manually prepared carrier route flats. The flats can either be delivered to the local postal office by the processing facility where the flats have been crossed docked or sorted on a Small Bundle Parcel Sorter (SBPS) or delivered directly from the mailer via destination unit drop shipment.

Parcels constitute another stream of mail pieces that the carrier receives. Parcels may arrive from the processing facility or directly from the mailer. Parcels are sorted to delivery route at the local postal office.

The mail carrier arranges the mail in manual cases and/or tubs based upon the practicalities of the route and the mix of mail to be delivered. After the casing operation has been completed, the carrier pulls the mail down from the cases and places each bundle or mail piece in delivery order sequence in a hard plastic tray. As each tray is filled, it is placed in a hamper. Thus, the carrier ends up with multiple containers of different types of mail. Carrier casing, pull down and fingering through multiple containers of mail is an inefficient, time consuming operation. Carrier productivity could be greatly enhanced if the carrier were to spend more time delivering mail than performing casing and sorting operations. Thus, there is a desire among postal services world wide to automate these manual operations.

### SUMMARY OF THE INVENTION

A method of processing unsorted mail pieces for delivery includes the steps of: (a) scanning the mail piece for destination information, (b) sorting the mail pieces onto a plurality of stacks, (c) transmitting delivery point destination information for each of the stack to a system controller, the system controller transmitting the information to a printer, (d) printing destination information for each of the stacks on wrapping material, the destination information being printed in human readable form, and (e) wrapping each stack with a section of wrapping material having human readable destination information printed on the wrapping material to create a bundle of mail pieces destined for the same delivery point. In one variation, the system controller transmits the information to a printer controller which, in turn, transmits the destination information to the printer. After wrapping, the bundles are loaded into a container. The amount of mail loaded in the container may be monitored with one or both of a proximity switch which measures the level of the stack of bundles in the container or a scale which monitors the weight of the container. When the level of the bundles of mail in the container reaches a predetermined height or the weight of the container reaches a predetermined amount, the system controller signals for an automated or manual replacement of the container with an empty container.

In another aspect, one or more dimensions of each stack of mail pieces is determined as the stacks are conveyed to the wrapping machine using detectors such as photo cells, an encoder or proximity switches. The system controller utilizes this information to determine the amount of wrapping material required to wrap the stack. The system controller also utilizes the dimensions of the stack to determine where the human readable destination information should be printed on the wrapping material. Preferably, the destination information appears in substantially the same location on each bundle of mail pieces and further, may be placed so as to not obscure advertising appearing on the mail pieces. Preferably, the wrapping material is thin plastic film which may be opaque or transparent, depending upon the particular application. One wrapping machine believed to be suitable for use in the practice of the invention is the Eclipse-640 polywrap system provided by Eclipse systems, Buckingham, United Kingdom.

In yet another aspect, the system controller is programmed to transmit an abbreviated form of the human readable destination information to the printer controller, thereby reducing the cycle time of the printer and the amount of material needed.

### BRIEF DESCRIPTION OF THE DRAWINGS

FIG. 1 is a schematic representation of one system suitable for practicing the method of the invention;

FIG. 2 is a front view of a first bundle of mail wrapped in accordance with the invention;

FIG. 3 is an end view of the bundle of FIG. 2;

FIG. 4 is a front view of a second bundle of mail wrapped in accordance with the invention; and

FIG. 5 is an end view of the bundle of FIG. 4.

### DETAILED DESCRIPTION

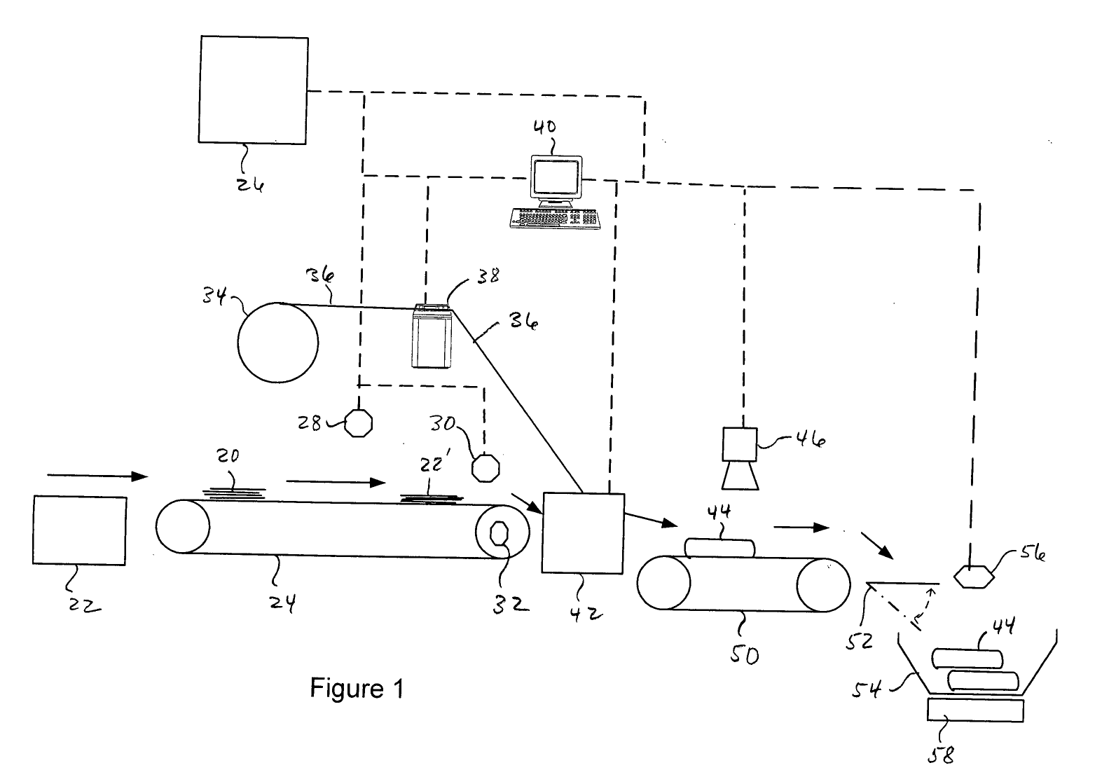

Referring to FIG. 1, in a mail packaging and addressing system 10 of the invention, stacks 20 of mail pieces are received from a sorting device 22 and loaded onto a conveyor 24. Sorting device 22 may comprise a conventional sorting machine such as a DBCS (Delivery Bar Code Sorter) or other sorting machine such as disclosed in U.S. Pat. No. 6,659,263, issued Dec. 9, 2003 to Hendrickson et al., U.S. Pat. No. 6,555,776 issued Apr. 29, 2003 to Roth et al. or Schererz et al., U.S. patent application Ser. No. 09/969,274, filed Oct. 2, 2001 (Publication No. U.S. 20020070149). The disclosures of each of the foregoing references are incorporated herein by reference for all purposes.

Each “stack” 20 of mail is destined for a single address and may comprise a single letter, flat or small parcel, groups of letters, flats or small parcels or a single group consisting of a mix of letters, flats or small parcels. Thus, the sizes of stacks 20 will vary depending upon the amount and type of mail destined for a particular delivery point. The delivery point address of each stack has previously been recorded either with a scanner associated with sorting device 22 or other automated sorting system, or manually, depending upon the particular application. The delivery point address of each stack 22 is transmitted to system controller 26 for use in applying. address information to stacks 20.

As stacks 20 are transported by conveyor 24, the leading and trailing edges of each stack 20 are sensed with a position detector mounted adjacent to conveyor 24 such as a photocell 28. Conveyor 24 is also provided with an encoder 32 or a similar speed sensing device that transmits a signal to system controller 26 indicating the speed of conveyor 24. Utilizing the signals from position indicator 28 and encoder 32 along with the destination codes assigned to stacks 20, system controller 26 can track the position of a particular stack 20 bound for a particular destination as the stack travels along conveyor 24. System controller 26 can also calculate the length of each stack utilizing the input from photocell 28 which registers the leading and trailing edges of each stack and encoder 32 which transmits the speed of conveyor 24 to system controller 26.

As illustrated, a roll 34 of wrapping film 36 is positioned adjacent conveyor 24 for wrapping stacks 20. Preferably, wrapping film 36 is an opaque or transparent polymer film such as a polyethylene polymer or copolymer. Film 36 is fed from roll 34 through or past a printer 38 which is controlled with printer controller 40 which also controls the operation of conveyor 24. Printer controller 40 is interfaced with system controller 26 which transmits the destination information for stack 20 to printer controller 40. Printer controller 40 in turn directs printer 38 to print the destination information for stack 20, in human readable form, on a section of film 36 which will be used to package stack 20. Conveyor 24 transports stack 20 to an automated packaging machine 42 that wraps stack 20 with the preprinted section of film 36 to create a package or bundle 44 of mail destined for a single address. Bundles 44 are then discharged onto a transfer conveyor 50.

In one variation, system controller 26 includes a database including abbreviated forms of human readable destination information for a plurality of delivery points within the area served or a program for abbreviating human readable language. In this variation, system controller 26 transmits an abbreviated version of the destination information to printer controller 40, enabling printing of abbreviated human readable destination information on film 36. Further, in the case of most route carriers, the city, state and zip code information will be irrelevant as the carrier will likely need only enough information to identify a delivery point on his or her route. Thus, for example, “200 Broadway Street, Neverville, N.J. 24568” may be printed as “200 Bor S” thereby minimizing the amount of time and material required to print the information.

In addition to the delivery point information, printer 38 may optionally print a bar code on film 36 that is subsequently scanned by a downstream bar code scanner 46 after stack 20 has been wrapped. The bar code is used to ensure that the sequencing of stacks 20 and bundles 44 is maintained in the correct order according to the sequence of addresses that system controller 26 transmits to printer controller 40.

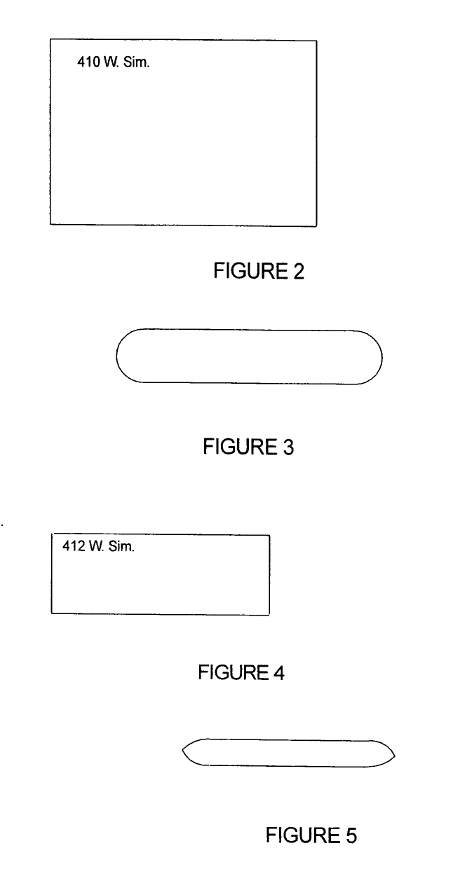

System controller 26 may also calculate the amount of film 36 required to wrap a particular stack based upon the signals from position detector 28 which transmits a leading edge detection signal along with a trailing edge detection signal for each stack 20. If desired, a second detector 30 such as a proximity sensor or a vertically aligned array of photo cells may be used in conjunction with or incorporated into position detector 28 to determine the height of each stack 20 in order to provide additional data for determining the amount of wrapping material needed to wrap a particular stack 20. Since bundles 44 will contain different sizes and amounts of mail pieces, the bundles will vary in size. Thus, for example, a bundle including magazines of catalogues could have the profile illustrated in FIGS. 2 and 3, whereas a bundle including several letters could have the profile illustrated in FIGS. 4 and 5.

System controller 26 utilizes the data collected by detectors 28 and 30 regarding the length and height of stack 20 to determine the location on film 36 to print human readable destination code information. The system controller then directs printer controller 40 to print the human readable destination information on film 36 at the calculated location such that the destination information appears at a predetermined or preselected location on each of bundles 44. Thus, as illustrated in FIGS. 2 and 4, the delivery point information, in abbreviated form, could appear on the upper left hand corner of bundles 44. Printing the delivery point information at the same relative location on each bundle aids the carrier in quickly finding and separating mail destined for a given delivery point.

In one variation, the location on bundle 44 where the destination information is printed is such that advertising or other information displayed on mail pieces in bundles 44 is not obscured when the stacks are wrapped with film 36. In this case, film 36 is preferably transparent, at least in the area where it is desired to expose the mail piece. In order to provide the desired contrast for the printed destination information while simultaneously exposing a mail piece in the bundle, it may be necessary to utilize a film 36 having opaque and transparent regions. Thus, if the delivery point information is printed with a dark ink, it may be desirable to utilize a film 36 having a white opaque border region where the destination information is printed while the remainder of film 36 is transparent.

After stacks 20 have been converted to bundles 44, the bundles are conveyed via transfer conveyor 50 past bar code scanner 46 to a loading guide 52. Loading guide 52 is configured to be inserted in container 54 such that bundles 44 are loaded in container 54 with a minimum amount of handling stress. In one variation, guide 52 may comprise a pivoting conveyor or slide. In another variation, guide 52 may be a device that physically grasps bundle 44, such as a pair of opposed belt conveyors between which bundles 44 are conveyed into container 54 at a controlled velocity.

As bundles 44 accumulate in container 54, a proximity sensor 56 senses the height of the stack of bundles 44 in container 54 and transmits the information to system controller 26. When the stack of bundles 44 reaches a predetermined level, system controller 26 signals for a manual or automated replacement of container 54 with an empty container. In one embodiment, the signal from system controller 26 activates an audible alarm to notify the operator that container 54 needs to be replaced or emptied. In a more sophisticated system, the signal from system controller 26 activates an automated system for emptying or replacing container 54. Upon determining that container 54 needs to be emptied or replaced, system controller 26 also signals printer controller 40 to shut down conveyor 24 until container 54 has been replaced with an empty container.

Alternatively, or in addition to proximity sensor 56, a scale 58 may be used to monitor the weight of container 54. As bundles 44 are loaded into container 54, scale 58 transmits a signal to system controller 26. When container 54 reaches a predetermined weight, system controller 26 signals printer controller 40 to shut down conveyor 24 and transmits a signal requesting replacement of container 54 with an empty container.

While certain embodiments of the invention have been illustrated for the purposes of this disclosure, numerous changes in the method and apparatus of the invention presented herein may be made by those skilled in the art, such changes being embodied within the scope and spirit of the present invention as defined in the appended claims. For example, while the above description describes separate system and printer controllers, it is contemplated that the functions of these units could be combined in a single microprocessor or similar computer. Similarly, while the preferred wrapping material is a plastic film, it is contemplated that other materials such a paper or a non-woven plastic web could be employed as the wrapping material, depending upon the application and economics.

We claim:

1. A method of processing unsorted mail pieces for delivery comprising:
sorting mail pieces destined for delivery to a single delivery point into a group;
printing human readable destination information corresponding to the delivery point of the group on a section of wrapping material; and
wrapping the group of mail pieces with the wrapping material bearing the human readable destination information.

2. The method of claim 1 further comprising the step of scanning the mail pieces for destination information.

3. The method of claim 1 wherein the wrapping material is a plastic film.

4. The method of claim 1 wherein the group of mail pieces comprises a stack, the method further comprising determining the size of the stack.

5. The method of claim 4 further comprising determining the amount of wrapping material needed to wrap the stack.

6. The method of claim 5 further comprising determining a location on the wrapping material for printing the human readable destination information such that the human readable information appears at a predetermined location on the stack after the mail pieces have been wrapped.

7. The method of claim 5 further comprising printing the human readable destination information on the wrapping material such that the human readable information appears at a predetermined location on the group after the mail pieces have been wrapped.

8. The method of claim 1 further comprising the step of printing a machine readable code on the wrapping material; and
scanning the machine readable code after the group of mail pieces has been wrapped.

9. The method of claim 1 further comprising printing the human readable destination information in an abbreviated form.

10. A method of processing unsorted mail pieces for delivery comprising:
scanning the mail pieces for destination information;
sorting the mail pieces into a plurality of stacks;
transmitting delivery point destination information for each of the stacks to a system controller, the system controller transmitting the information to a printer;
printing destination information for each of the stacks on wrapping material, the destination information being printed in human readable form; and
wrapping each stack with a section of wrapping material having human readable destination information printed on the wrapping material to create a bundle of mail pieces destined for the same delivery point.

11. The method of claim 10 further comprising the step of transmitting the destination information from the system controller to a printer controller.

12. The method of claim 10 further comprising loading the bundles into a container;
monitoring one of the level of the stacks in the container as the stacks are loaded into the container; and
transmitting a signal when the level of the bundles in the container reaches a predetermined level.

13. The method of claim 10 further comprising loading the bundles into a container;
monitoring the weight of the container as the bundles are loaded into the container; and
transmitting a signal when the weight of the container reaches a predetermined level.

14. The method of claim 10 further comprising determining at least one dimension of each stack;
using the dimension to determine the location on the wrapping material where the destination information will be printed.

15. The method of claim 10 further comprising determining a location on the wrapping material for printing the human readable destination information such that the human readable information appears at a predetermined location on each of the bundles after the mail pieces have been wrapped.

16. The method of claim 10 further comprising the step of printing a machine readable code on the wrapping material; and
scanning the machine readable code after the stack or pieces has been wrapped.

17. The method of claim 10 wherein the human readable destination information is printed on the wrapping material in an abbreviated form.

18. The method of claim 10 wherein the wrapping material is a plastic film.
